(19) United States
(12) Patent Application Publication
(10) Pub. No.: US 2018/0022070 A1
(43) Pub. Date: Jan. 25, 2018

(54) VEHICLE HEADLINER MATERIAL

(71) Applicant: Daehan Solution Co. , Ltd., Incheon (KR)

(72) Inventors: Choong Ho Kwon, Seoul (KR); Yungeun Gwak, Incheon (KR); SeokJun Yong, Incheon (KR); Sang-Min Kim, Incheon (KR)

(21) Appl. No.: 15/378,606

(22) Filed: Dec. 14, 2016

(30) Foreign Application Priority Data
Jul. 21, 2016 (KR) 10-2016-0092780

(51) Int. Cl. B32B 17/10; B60R 13/02; B32B 7/12

(52) U.S. Cl. CPC B32B 17/10073; B32B 17/10082; B32B 7/12; B60R 13/0212; B32B 2307/72; B32B 2605/00

(57) ABSTRACT

A vehicle headliner material includes a stiffening layer for reinforcing each side of a thermoplastic resin layer so that the material satisfies required bending stiffness while having lighter weight and thus can prevent safety accidents that may occur due to increasing of headliner material weight. In particular, by using a glass mat, with a thermoplastic resin sheet on each side thereof, that constitutes a part of each stiffening layer to reinforce structural stiffness of the material, the vehicle headliner material has improved formability, improved flexural strength, and direct adhesion without an additional adhesive or the like. Also, by not using polyurethane foam to prepare the vehicle headliner material, problems such as generation of dust derived from processing polyurethane foam into sheets can be eliminated, and safe and pleasant working environments can be provided for workers.

### CROSS-REFERENCE TO RELATED APPLICATION

This application claims priority to and the benefit of Korean Patent Application No. 10-2016-0092780, filed Jul. 21, 2016, the disclosure of which is incorporated herein by reference in its entirety.

### BACKGROUND

### 1. Field of the Invention

The present invention relates to a vehicle headliner material. More particularly, the present invention relates to a vehicle headliner material configured to have a thermoplastic resin layer and a stiffening layer on each side of the thermoplastic resin layer, wherein the stiffening layer includes thermoplastic resin sheets and a glass mat. In this case, the vehicle headliner material is light, has excellent bending stiffness, and is easily produced with a simple layer structure. Also, in particular, the vehicle headliner material can be prepared in safe and pleasant working environments because the preparation thereof does not involve making a sheet out of polyurethane foam, which is a process that generates dust and the like.

### 2. Discussion of Related Art

A headliner (1) as illustrated in FIGS. 1 and 2 refers to an interior material installed in an interior of a vehicle in such a way that it faces a roof panel (R) to improve the appearance of the interior and reduces noise. Along with floor carpets, the headliner is one of important finishing materials used to reduce noise. Being installed over the heads of a driver and passengers, the headliner is configured to have a low overall weight to improve noise problems in a safe way. As described in Patent Documents 1 to 3 provided below, various materials are used to prepare such a headliner.

(Patent Document 1) Korean Patent No. 1198967

The document relates to a method of preparing a vehicle headliner by directly preheating a headliner material using an upper heat plate and a lower heat plate, instead of using a conventional way of indirectly preheating the headliner material using a ceramic oven. In this way, productivity can be improved because headliners of uniform quality can be produced in a shorter time.

(Patent Document 2) Korean Patent No. 1279522

The document relates to a method of preparing a natural-fiber reinforced composite board that can be used as a vehicle interior material, such as a headliner, by using thermoplastic matrix fibers, thermoplastic reinforced fibers, natural fibers, and the like. According to this method, problems related to low thermal stability of common thermoplastic matrix fibers, such as polypropylene fibers and core and sheath type composite fibers based on a low melting point polyester, are improved by improving degrees of crystallinity and adhesion of thermoplastic matrix fibers. In this case, the natural-fiber reinforced composite board that has been developed as thus serves as a reliable vehicle interior material.

(Patent Document 3) Korean Patent No. 1383780

The document relates to a method of preparing a vehicle headliner by way of directly preheating a headliner material using an upper heat plate and a lower heat plate, which are set at mutually different temperatures, instead of using a conventional method of indirectly preheating the headliner material using a ceramic oven. In this way, not only can productivity be improved because headliners of uniform quality can be produced in a shorter time, but also sound absorption by the headliner can be enhanced, thus interior noise of the vehicle is reduced, and a pleasant environment is provided for a user.

However, to improve noise-dampening performance, a conventional headliner material (1′) is produced with a layer structure as shown in FIG. 3. In this case, a headliner may consist of a single headliner material (1′) as shown in FIG. 3 or a multiple layer structure built on a headliner material.

As shown in FIG. 3, the conventional headliner material (1′) has a laminate structure prepared by disposing a glass mat (4) and a nonwoven fabric (6) (written in order from closest to farthest from the polyurethane foam sheet (2)) on each side of a polyurethane foam sheet (2). In this case, an adhesive (3) is applied between the polyurethane foam sheet (2) and the glass mat (4) to glue the layers together, and a hot melt film (5) is attached between the mat (4) and the nonwoven fabric (6) to achieve an integrated multiple layer structure.

However, the conventional headliner material including a polyurethane foam sheet has the following problems:

(1) The polyurethane foam, effective for improving noise dampening performance, is conventionally prepared as sheets by processing the foam into a block that is then cut at a desired thickness. During the process of cutting the polyurethane foam into polyurethane foam sheets, much dust is generated and acts as a factor in degrading working environments.

(2) In particular, unless properly removed, the dust may be inhaled and enter the respiratory systems of workers through lungs, possibly causing industrial injuries at work, such as respiratory diseases and the like.

(3) Meanwhile, polyurethane foam exhibits excellent noise dampening performance but has low stiffness. Therefore, to prepare a headliner material, the low bending stiffness should be reinforced by cutting polyurethane foam into layers with a large thickness or using a reinforcing material or the like. However, so doing results in a headliner material with a complex layer structure.

(4) Hence, the conventional headliner material becomes large in thickness and weight and thus acts as a factor in degrading fuel efficiency as well as utilization of a vehicle's limited interior space.

(5) In addition, the large weight of the headliner material may cause the headliner to sag over time and eventually deform or fall to the floor of the vehicle. In the case of the vehicle being occupied, an injury to a driver and/or a passenger(s) may result.

### CONVENTIONAL ART DOCUMENTS

### Patent Documents

(Patent Document 1) Korean Patent No. 1198967 (Registered on Nov. 1, 2012)

(Patent Document 2) Korean Patent No. 1279522 (Registered on Jun. 21, 2013)

(Patent Document 3) Korean Patent No. 1383780 (Registered on Apr. 3, 2014)

### SUMMARY OF THE INVENTION

In consideration of the aforementioned problems, embodiments of the present invention are directed to providing a vehicle headliner material, wherein the vehicle headliner material satisfies bending stiffness requirements while having lighter weight by including a stiffening layer to reinforce each side of a thermoplastic resin layer and thus is capable of preventing safety accidents that may occur due to increased headliner material weight.

Also, in particular, the described embodiments are directed to providing a vehicle headliner material with further improved formability, further improved flexural strength, and direct adhesion without an additional adhesive or the like by using a glass mat, with a thermoplastic resin sheet on each side thereof, that constitutes a part of each stiffening layer to reinforce structural stiffness of the material.

In addition, the described embodiments are directed to providing a vehicle headliner material without using polyurethane foam so that problems, such as generation of dust, derived from processing polyurethane foam into sheets can be eliminated, and safe and pleasant working environments can be provided for workers.

In order to fulfill the above objectives, the described embodiments provide a vehicle headliner material that includes a thermoplastic resin layer; and a stiffening layer disposed on each side of the thermoplastic resin layer, wherein each stiffening layer includes a glass mat as a middle layer and a thermoplastic resin sheet on each side of the glass mat.

In particular, the thermoplastic resin layer may have a thickness of 3 to 5 mm and an areal density of 150 to 250 g/m². In this case, the thermoplastic resin layer may be prepared using at least one selected from the group consisting of vinyl chloride resins, polystyrene (PS) resins, acrylonitrile butadiene styrene (ABS) resins, acrylic resins, polyethylene (PE) resins, nylon resins, and polyacetal resins.

Also, the stiffening layer may have a thickness of 1 to 2 mm and an areal density of 100 to 500 g/m².

In addition, the glass mat may have an areal density of 50 to 200 g/m².

Also, the thermoplastic resin sheet may have a thickness of 20 to 250 μm.

Meanwhile, the thermoplastic resin sheet may consist of at least one selected from the group consisting of polyvinyl chloride (PVC), PS, polypropylene (PP), PE, and polyethylene terephthalate (PET).

The headliner material according to the described embodiments may have an overall thickness of 3 to 7 mm and an areal density of 700 to 900 g/m².

The vehicle headliner material according to the described embodiments has the following effects:

(1) By including a stiffening layer attached to each of both sides of the thermoplastic resin layer that is made of a thermoplastic resin, the vehicle headliner material has reduced weight and enhanced flexural strength and thus can improve fuel efficiency, safety, and ease of use.

(2) Also, since a thermoplastic resin layer, rather than conventional polyurethane foam, is used to prepare the vehicle headliner material, problems such as generation of dust caused by the processing of polyurethane foam into sheets can be eliminated, and thus safe and pleasant working environments can be provided for workers.

(3) Meanwhile, since each stiffening layer is configured with a glass mat and thermoplastic resin sheets, no additional adhesive is necessary to glue the thermoplastic resin layer and stiffening layer together. As the use of an additional adhesive is not required, the vehicle headliner material can be prepared easily, safety accidents that may be caused by the use of an adhesive can be prevented, and working environments can be improved.

(4) In particular, since each thermoplastic resin sheet provides adhesion, use of an adhesive, such as a glue, to provide adhesion in a conventional manner is not necessary. Not only does this make the preparation of the vehicle headliner material more convenient, safer, and capable of being completed in fewer steps, it can also reduce bronchial system health risks for the workers due to glue smell or the like, reduce vehicle passenger health risks by eliminating adhesive smell when conventional headliner materials is installed in a vehicle, and create a pleasant environment in the vehicle interior.

(5) Moreover, the vehicle headliner material with a reduced thickness can result in better use of the limited interior space of a vehicle.

### BRIEF DESCRIPTION OF THE DRAWINGS

The above and other objects, features and advantages of the described embodiments will become more apparent to those of ordinary skill in the art by describing in detail exemplary embodiments thereof with reference to the accompanying drawings, in which:

FIG. 1 is a perspective view of a vehicle for showing a position of a headliner installed in the vehicle;

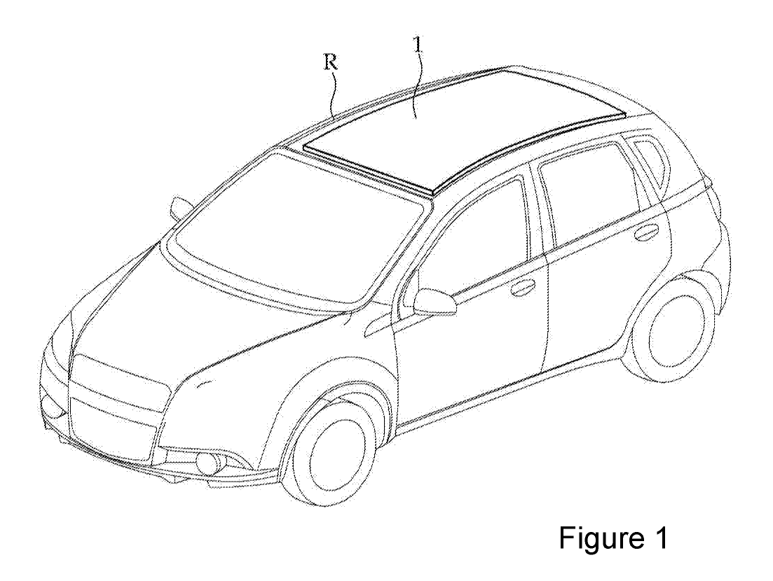

FIG. 2 is a top plan view for illustrating the entire shape of a conventional headliner;

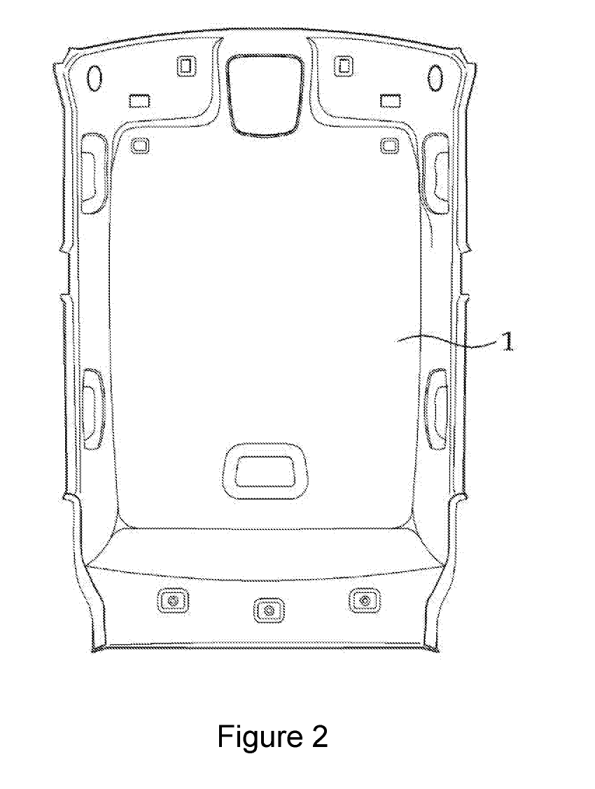

FIG. 3 is a cross-sectional view for illustrating a layer structure of a material for a conventional headliner; and

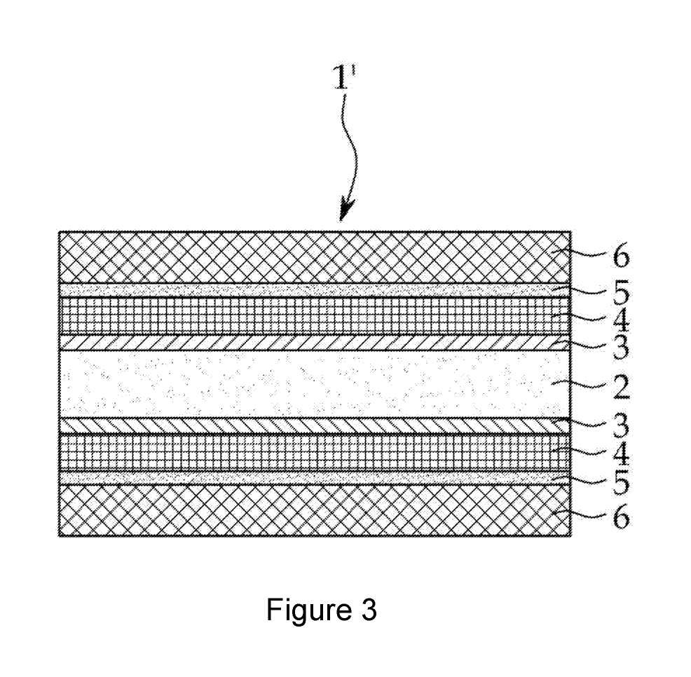

FIG. 4 is a cross-sectional view for illustrating a layer structure of a headliner material according to the described embodiments.

### DETAILED DESCRIPTION OF EXEMPLARY EMBODIMENTS

Hereinafter, exemplary embodiments of the present invention will be described in more detail with reference to accompanying drawings. Moreover, terms and words used in this specification and claims should not be interpreted as being limited to commonly used meanings or meanings in dictionaries and should be interpreted with meanings and concepts which are consistent with the technological scope of the present invention based on the principle that the inventors may appropriately define concepts of terms in order to describe the invention in the best way.

Therefore, since the embodiments described in this specification and configurations illustrated in drawings are only exemplary embodiments and do not represent the entire technological scope of the invention, it is understood that the described embodiments cover various equivalents, modifications, and substitutions at the time of filing of this application.

(Configuration)

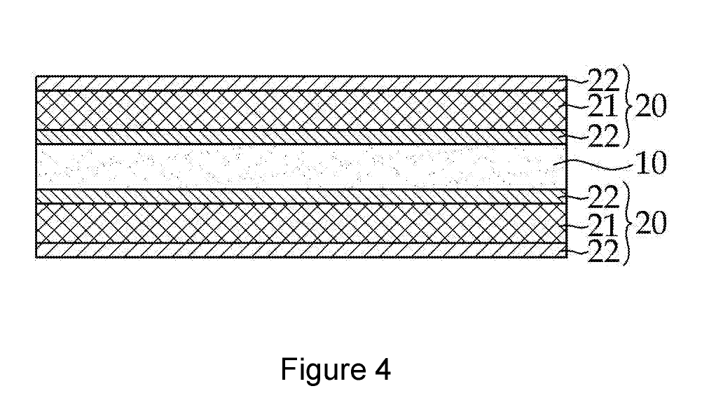

As shown in FIG. 4, the vehicle headliner material according to an exemplary embodiment includes a thermoplastic resin layer 10, and a stiffening layer 20 attached to each side of the thermoplastic resin layer 10.

In particular, since the thermoplastic resin layer 10 consists of a thermoplastic resin and each stiffening layer 20 includes a glass mat 21 and a thermoplastic resin sheet 22, the vehicle headliner material may have a simple and thin layer structure, be lightweight, and have desired flexural strength.

In this case, the stiffening layer 20 is configured to include the glass mat 21 to improve formability and structural stiffness of the headliner material to enhance bending stiffness while enabling the formation of a headliner with a complex shape. Also, the thermoplastic resin sheet 22 included in the headliner material provides adhesion for gluing the thermoplastic resin layer 10 and stiffening layer 20 together without using an additional adhesive or the like.

Hereinafter, the configuration of the headliner material will be described in more detail. Here, the headliner material according to an exemplary embodiment may be one among many layers constituting a layer structure of a headliner, or the headliner material itself may represent the entire layer structure of a headliner.

The thermoplastic resin layer 10 as shown in FIG. 4 refers to a layer prepared by shaping a thermoplastic resin into a sheet to enhance noise dampening performance of a headliner and for making a lighter headliner material. In this case, at least one selected from the group consisting of vinyl chloride resins, polystyrene (PS) resins, acrylonitrile butadiene styrene (ABS) resins, acrylic resins, polyethylene (PE) resins, nylon resins, and polyacetal resins may be used as the thermoplastic resin.

Therefore, the thermoplastic resin layer 10 is expected to possess certain bending stiffness and structural stiffness, thus being capable of preventing safety accidents related to headliner sagging or/and deforming, or sagging and eventually falling to the floor of the vehicle.

In consideration of noise dampening performance and weight increase, the thermoplastic resin layer 10 is preferably configured to have a thickness of 3 to 5 mm and an areal density of 150 to 250 g/m².

The stiffening layer 20 as shown in FIG. 4 is disposed on each side of the above thermoplastic resin layer 10 to prevent moisture or the like from entering the thermoplastic resin layer 10 and is configured for gluing layers together as a single entity. For this purpose, each stiffening layer 20 is prepared by attaching a thermoplastic resin sheet 22 to each side of a glass mat 21.

In this case, the glass mat 21 has excellent formability and can be easily shaped into a complex shape. In particular, the glass mat 21 provides stiffness to the headliner material of the exemplary embodiment to enhance flexural strength of the headliner material so that the headliner does not easily sag or deform. For sufficient bending stiffness and to minimize weight increase, it is preferable that the glass mat 21 be configured to have an areal density of 50 to 200 g/m².

The thermoplastic resin sheet 22 as shown in FIG. 4 is attached to each side of each glass mat 21 to provide adhesion and prevent moisture penetration when a stiffening layer 20 is bonded to a thermoplastic resin layer 10.

Any thermoplastic resin that serves as an adhesive may be used to prepare the thermoplastic resin sheet 22. For example, at least one selected from the group consisting of polyvinyl chloride (PVC), PS, polypropylene (PP), PE, and polyethylene terephthalate (PET) may be used as the thermoplastic resin.

In particular, for using the thermoplastic resin sheet 22 as an adhesive component, it is preferable that the thermoplastic resin sheet 22 be prepared with a minimum possible thickness that can promote adhesion between the thermoplastic resin layer 10 and stiffening layer 20. For this purpose, the thermoplastic resin sheet 22 is preferably configured to have a thickness of 20 to 250 μm.

Meanwhile, the stiffening layer 20 of the exemplary embodiment prepared as thus is preferably disposed on each side of the thermoplastic resin layer 10 as shown in FIG. 4. Also, the stiffening layer 20 is preferably prepared with a minimum possible thickness and weight to promote adhesion with the thermoplastic resin layer 10 while not adding too much weight to the headliner material. Therefore, the stiffening layer 20 is preferably configured to have a thickness of 1 to 2 mm and an areal density of 100 to 500 g/m².

In addition, the headliner material according to the exemplary embodiment is preferably configured to have a thickness of 3 to 7 mm and an areal density of 700 to 900 g/m² to minimize moisture penetration and weight of the headliner material itself at the same time. In this case, the headliner material is preferably configured to have a flexural strength of 2.15 to 2.55 kg/cm².

By including a stiffening layer on each side of a thermoplastic resin layer for reinforcement as described above, the headliner material of the described embodiments can satisfy required bending stiffness with a simple layer structure and still be light for fuel efficiency improvement.

Also, by including a glass mat and thermoplastic resin sheets in each stiffening layer, the headliner material of the described embodiments can attain improved bending stiffness and be adhered without requiring an additional adhesive and used.

In addition, by not using polyurethane foam to prepare a headliner material, the described embodiments are expected to contribute to improving working environments and reducing health risks that may be caused by dust or the like generated while processing polyurethane foam into sheets.

### DESCRIPTION OF SYMBOL

10: THERMOPLASTIC RESIN LAYER
20: STIFFENING LAYER
21: GLASS MAT
22: THERMOPLASTIC RESIN SHEET

1. A material for a vehicle headliner, the material comprising:
a thermoplastic resin layer; and
a stiffening layer disposed on each side of the thermoplastic resin layer,
wherein each stiffening layer includes:
a glass mat as a middle layer; and
a thermoplastic resin sheet on each side of the glass mat.

2. The material according to claim 1, wherein the thermoplastic resin layer has a thickness of 3 to 5 mm and an areal density of 150 to 250 g/m².

3. The material according to claim 1, wherein the thermoplastic resin layer is prepared using at least one selected from the group consisting of vinyl chloride resins, polystyrene (PS) resins, acrylonitrile butadiene styrene (ABS) resins, acrylic resins, polyethylene (PE) resins, nylon resins, and polyacetal resins.

4. The material according to claim 1, wherein the stiffening layer has a thickness of 1 to 2 mm and an areal density of 100 to 500 g/m².

5. The material according to claim 1, wherein the glass mat has an areal density of 50 to 200 g/m².

6. The material according to claim 1, wherein the thermoplastic resin sheet has a thickness of 20 to 250 μm.

7. The material according to claim 1, wherein the thermoplastic resin sheet consists of at least one selected from the group consisting of polyvinyl chloride (PVC), PS, polypropylene (PP), PE, and polyethylene terephthalate (PET).

8. The material according to claim 1, wherein the material has an overall thickness of 3 to 7 mm and an areal density of 700 to 900 g/m².
